(19) United States
(12) Patent Application Publication
(10) Pub. No.: US 2026/0274646 A1
(43) Pub. Date: Sep. 17, 2026

(54) SYSTEMS AND METHODS FOR HANDS-FREE LIQUID TRANSFER BETWEEEN CONTAINERS

(71) Applicant: Starbucks Corporation, Seattle, WA (US)

(72) Inventor: Michael R. Cummer, Seattle, WA (US)

(73) Assignee: STARBUCKS CORPORATION, Seattle, WA (US)

(21) Appl. No.: 19/543,946

(22) Filed: Feb. 19, 2026

Related U.S. Application Data
(60) Provisional application No. 63/769,923, filed on Mar. 11, 2025.

(51) Int. Cl. B67D 99/00

(52) U.S. Cl. CPC B67D 99/00

(57) ABSTRACT

Systems and methods for hands-free liquid transfer between containers are described. For example, the hands-free liquid transfer can be performed at a physical location. A first container containing a liquid can be positioned above a second container. The first container can be prefilled with the liquid prior to arriving at the physical location. The first container can be rotated into an inverted position to begin pouring the liquid through an opening of the first container into the second container. While the liquid is pouring from the first container into the second container, the first container can be secured in the inverted position to the second container using an attachment assembly. The attachment assembly can maintain the first container in the inverted position over the second container without manual intervention, thereby allowing the liquid to flow through the opening of the first container into the second container without continuous manual effort.

### CROSS-REFERENCE TO RELATED APPLICATIONS

This claims the benefit of priority under 35 U.S.C. § 119(e) to U.S. Provisional Patent Application No. 63/769,923 filed Mar. 11, 2025, the entirety of which is hereby incorporated by reference herein.

### TECHNICAL FIELD

The present disclosure relates generally to liquid transfer. More specifically, but not by way of limitation, this disclosure relates to systems and methods for hands-free transfer of liquid from one container to another container.

### BACKGROUND

In various industries, the transfer of liquids from smaller containers to larger containers is a common practice. For instance, in the food service industry, liquid ingredients such as concentrated juices, non-dairy milks, sauces, or flavorings are frequently sent to stores in smaller containers designed for efficient transport and storage. Examples of these smaller containers include pouches, cartons, bottles, or similar packaging formats. After arriving at the stores, these ingredients are typically transferred into larger containers to facilitate their use in liquid dispensing equipment or other store-level operations. Examples of larger containers include reservoirs for liquid dispensing equipment, blender containers used in food preparation, or storage tanks for bulk usage.

### BRIEF DESCRIPTION OF THE DRAWINGS

FIG. 1 depicts a flowchart of an example of a process for hands-free liquid transfer between containers, according to some aspects of the present disclosure.

FIG. 2 depicts an example in which the process of FIG. 1 is repeated multiple times to concurrently pour liquids from multiple smaller containers into multiple larger containers, according to some aspects of the present disclosure.

FIG. 3 depicts a cross-sectional side view of an example of a first container attached to a second container via an attachment assembly according to some aspects of the present disclosure.

FIG. 4 depicts a cross-sectional side view of another example of a first container attached to a second container via an attachment assembly according to some aspects of the present disclosure.

FIG. 5 depicts a cross-sectional side view of another example of a first container attached to a second container via an attachment assembly according to some aspects of the present disclosure.

FIG. 6 depicts a cross-sectional side view of another example of a first container attached to a second container via an attachment assembly according to some aspects of the present disclosure.

FIG. 7 depicts a cross-sectional side view of an example of an attachment assembly according to some aspects of the present disclosure.

FIGS. 8A-B depict cross-sectional side views of an example an attachment assembly according to some aspects of the present disclosure.

### DETAILED DESCRIPTION

In various industries, liquids are poured between containers to support ongoing operations. For example, in establishments that serve beverages and food items, liquid ingredients are often transported to stores in smaller containers, such as 1-liter pouches or cartons, for convenient transport and storage. These liquids may then be transferred to larger containers, such as 3-liter reservoirs, which are used in liquid dispensing equipment or other equipment at the stores. The larger reservoirs reduce the frequency of refills and enable continuous operation of dispensing equipment during peak periods.

The process of transferring liquids between containers typically involves a user manually holding a first container, opening it, and inverting it to pour its contents into a second container. This manual approach can be time-consuming and laborious, particularly in high-demand environments. Moreover, manual pouring introduces inefficiencies, such as the inability to pour multiple containers simultaneously, and potential risks, including spillage, contamination, or strain injuries for users. These challenges are further compounded during peak operational periods, such as the beginning of the day, when numerous containers may need to be filled simultaneously to prepare equipment for operation. Additionally, spare containers may need to be filled in advance to ensure quick exchange during busy periods. This manual process is not only time-consuming but also restricts the user's ability to perform other essential tasks during busy operational hours.

Some examples of the present disclosure can overcome one or more of the abovementioned problems by providing systems and methods for hands-free pouring of liquid from a first container to a second container at a physical location, such as a store, manufacturing facility, or distribution center. The first container may be smaller in size, and thus may be designed to hold less liquid, than the second container. At the physical location, the first container can be rotated into an inverted position above the second container to begin pouring the liquid into the second container. While the liquid is pouring into the second container, the first container can be attached to the second container via an attachment assembly. The attachment assembly can secure and maintain the first container in the inverted position over the second container, thereby allowing the liquid to flow through an opening of the first container into the second container without continuous manual effort.

Using the techniques described herein, the first container's contents can be transferred to the second container without the need for continuous manual pouring. This can enable users to focus on other tasks while the transfer process is underway. For example, the users can prepare other ingredients, clean equipment, or attend to requests while the liquid transfer progresses autonomously. In addition, these systems and methods can support parallel operations, enabling a single user to fill multiple reservoirs or other large containers concurrently. This capability not only reduces the time required for equipment setup but also minimizes spillage, reduces ergonomic strain and injury, and enhances overall operational efficiency.

In some examples, the attachment assembly can be fixed to the second container. The attachment assembly may be fixed to the second container during the second container's manufacturing process or through a subsequent retrofit process. For instance, the attachment assembly can be integrally formed as part of the second container during the second container's manufacturing process. Advanced manufacturing techniques such as molding (e.g., injection molding, compression molding, bow molding, rotational molding, thermoforming, and/or extrusion molding) or 3D printing may be employed to integrate the attachment assembly seamlessly into the container's design. As another example, the attachment assembly can be retrofit onto the second container at the physical location using screws, bolts, clamps, adhesive, and/or an interference fit. Fixing the attachment assembly to the second container reduces the likelihood of loss or damage, ensures the attachment assembly is consistently available for use without requiring additional setup, prevents the user from forgetting to clean the attachment assembly since it is not a standalone part, and simplifies cleaning and maintenance protocols by integrating the attachment assembly into the container's structure. In some examples, the attachment assembly can be subsequently removed for maintenance or repair if damaged.

In some examples, the first container may arrive at the physical location prefilled with the liquid and sealed. In some such examples, the first container may be disposable and intended to be thrown away after a single use. Alternatively, the first container can be reusable and liquid can be added to the first container at the physical location. In this way, the first container may be repeatedly filled with one or more liquids and emptied into one or more other containers in a hands-free manner using the techniques described herein. Reusable containers may be equipped with advanced sealing and attachment features to facilitate repeated use without compromising hygiene or efficiency.

In some examples, the attachment assembly may include adjustable features that can accommodate non-standard container shapes or slanted designs. The attachment assembly can be tailored to meet the specific needs of different industries, such as food service or chemical manufacturing.

This introduction is provided to discuss the general subject matter described herein and is not intended to limit the scope of the disclosed concepts. The following sections describe various additional features and examples with reference to the drawings, but also should not be used to limit the present disclosure.

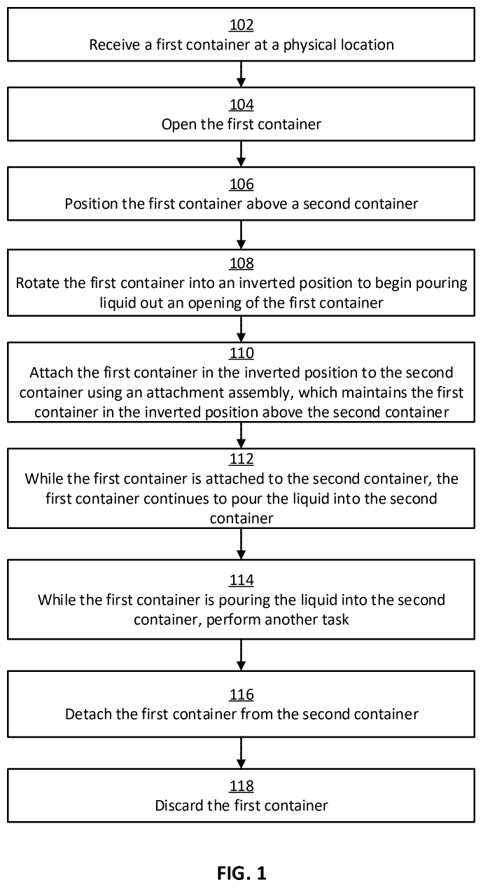

Turning now to FIG. 1, shown is a flowchart of an example of a process for hands-free liquid transfer between containers, according to some aspects of the present disclosure. Other examples may involve more operations, fewer operations, different operations, or a different sequence of operations than is shown in FIG. 1. Some or all of the steps shown in FIG. 1 may be performed at a physical location, such as a coffee café or cafeteria.

In block 102, a first container is received at the physical location. Examples of the first container may include pouches or cartons, which may be designed to hold smaller volumes of liquid. In some examples, the first container may have a capacity ranging from 0.1 liters to 1.0 liters of liquid, inclusive. For instance, the first container may be sized to hold up to 0.1, 0.2, 0.3, 0.4, 0.5, or 0.6 liters of liquid. The first container may be formed from any suitable material, such as plastic, cardboard, metal, or any combination thereof.

The first container may be pre-filled with the liquid and sealed prior to arriving at the physical location. For example, the physical location may be associated with a first entity. The first entity may be a provider of edible items (e.g., food and/or beverages) to customers. Before the first container arrives at the physical location, a second entity may fill the first container with the liquid at a manufacturing facility, which is remote from the physical location. The second entity may then seal the first container using a cap, adhesive, or other seal. The second entity can be different from the first entity. The first container can then be transported from the manufacturing facility to the physical location.

In block 104, the first container is opened at the physical location. For example, a user (e.g., a human user such as a barista) can manually open the first container by removing or puncturing a cap or other seal. This may involve the user holding the first container with one hand and removing/puncturing the cap or other seal with their other hand. In some examples, the first container may contain only a single nozzle or opening through which the liquid is intended to be poured out from the first container. For instance, the first container may be a pouch or carton with only a single nozzle or opening for filling and emptying the first container. The nozzle or opening may be capped or otherwise sealed prior to arriving at the physical location. The user can remove the cap or seal from the nozzle or opening to expose the liquid in the first container.

In block 106, the first container can be positioned above a second container at the physical location. For instance, the user can grasp the second container and manually lift it above the first container to position at least part of the first container overtop of the second container. When the first container is positioned over the second container, there may be a vertical gap between the first container and the second container (e.g., a vertical space between the lowermost part of the first container and the uppermost part of the second container).

In some examples, the second container may include an equipment reservoir, mixing bowl, blender container, pitcher, or storage tank, which may be designed to hold larger volumes of liquid. Thus, the second container may be larger in volume than the first container. In some examples, the second container may have a capacity ranging from 1.1 liters to 5.0 liters of liquid, inclusive. For instance, the second container may be sized to hold up to 2.0, 2.5, 3.0, 3.5, or 4.0 liters of liquid. The second container also have a larger outer perimeter (e.g., outer circumference) than the first container. The second container may be formed from any suitable material, such as plastic, cardboard, metal, or any combination thereof.

Prior to this step, the second container can be received at the physical location. In some examples, the second container can be manufactured by the first entity and transported to the physical location. Alternatively, the second container can be manufactured by a third entity, which can be different from the first entity, and transported to the physical location. The third entity may be the same as or different from the second entity that manufactures the first container.

In block 108, the first container can be rotated into an inverted position to begin pouring the liquid out an opening of the first container. For example, a user can grasp the first container by hand and rotate the first container into the inverted position above the second container, so that the liquid begins to pour from the first container into the second container. If the first container has a nozzle, the liquid may pour through an opening in the nozzle from the first container into the second container. The second container may be substantially empty prior to the pouring. Alternatively, the second container may be partially filled (e.g., with the same liquid that is in the first container or another liquid) prior to the pouring.

In block 110, while the liquid is still pouring from the first container to the second container, the first container can be attached to the second container using an attachment assembly. For example, the user can manually lower the first container in the inverted position onto the attachment assembly or otherwise manually attach the first container to the second container using the attachment assembly. The attachment assembly can maintain the first container in the inverted position overtop of the second container, so that the liquid continues to pour from the opening of the first container into the second container. Once the first container is attached to the second container using the attachment assembly, the user can remove their hand from the first container so that the liquid pouring can continue hands-free.

Prior to this step, the attachment assembly may have been previously fixed to the second container. For example, the attachment assembly may be a built-in part of the second container, such that it is integral with the second container. As another example, the attachment assembly may have previously been fixed (e.g., by the user or another user) to the second container by a coupling mechanism, such as one or more screws, glues, bolts, clamps, or any combination of these. For instance, the attachment assembly may include a coupling mechanism configured to engage in an interference fit with the second container. Once fixed to the second container, the attachment assembly is readily available for use during this step as a connected part of the second container.

Alternatively, prior to this step, the attachment assembly may have been previously fixed to the first container. For example, the attachment assembly may be a built-in part of the first container, such that it is integral with the first container. As another example, the attachment assembly may have previously been fixed (e.g., by the user or another user) to the first container by a coupling mechanism, such as one or more screws, glues, bolts, clamps, or any combination of these. For instance, the attachment assembly may include a coupling mechanism configured to engage in an interference fit with the first container. Once fixed to the first container, the attachment assembly can be readily available for use during this step as a connected part of the first container.

In block 112, while the first container is attached to the second container (e.g., via the attachment assembly), the first container can continue to pour the liquid into the second container. This can occur in a hands-free manner without continued assistance by the user.

In block 114, while the first container is pouring the liquid into the second container, the user can perform another task, because the user no longer needs to be involved in the pouring process. For example, the user can perform other steps to prepare a beverage or food item for a recipient. This may involve heating a food item, blending liquids, preparing a topping, cleaning equipment or smallware, obtaining ice, etc.

In some examples, the user can perform another task involving repeating some or all of the process shown in FIG. 1 for another pair of first and second containers, so that both pairs of containers are engaged in hands-free fluid transfer at the same time.

In block 116, the first container can be detached from the second container. For example, the user may disengage the first container or the second container from the attachment assembly to remove the first container from the second container. In some examples, the first container can be detached from the second container when the first container is substantially empty. As used herein, a container can be considered “substantially empty” when it has less than 3% of its volume filled with liquid, including when it is completely empty.

In block 118, the first container can be discarded. For example, the user can throw the first container away into a waste bin or other bin at the physical location. In some such examples, the first container may be a single-use container intended to be disposed of after one use.

In other examples, the first container may be reusable, so this step may be skipped. The first container may be refilled with liquid at the physical location and some or all of the process (e.g., steps 106-114) may be repeated at a future point in time.

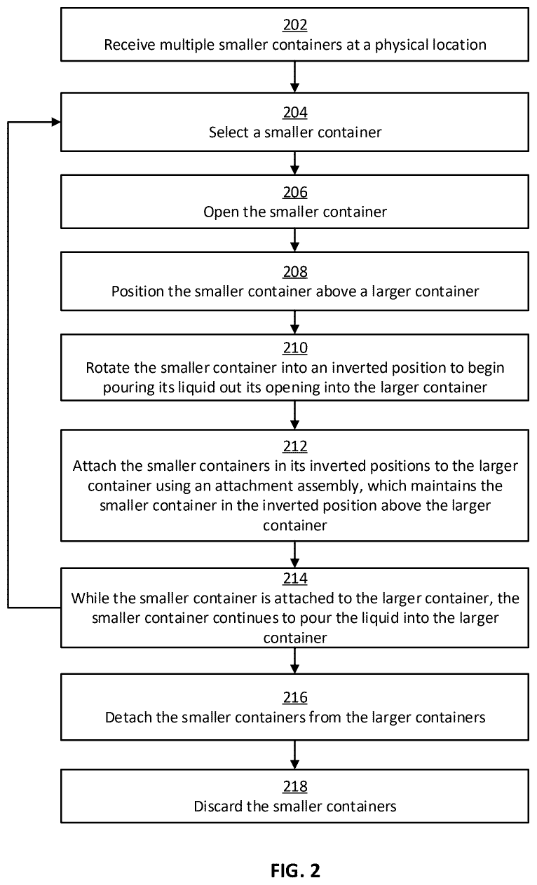

Turning now to FIG. 2, shown is an example in which the process of FIG. 1 is repeated multiple times to concurrently pour liquids from multiple smaller containers into multiple larger containers, according to some aspects of the present disclosure. The smaller containers can be smaller in volume than the larger containers.

In block 202, multiple smaller containers can be received a physical location. The smaller containers may be received at the physical location from the same entity or different entities. The smaller containers may contain the same liquid or different liquids from one another.

The smaller containers may be prefilled with liquids and sealed prior to arriving at the physical location. For example, the physical location may be associated with a first entity. The first entity may be a provider of edible items (e.g., food and/or beverages), such as Starbucks®. Before the smaller containers arrive at the physical location, one or more second entities may fill the smaller containers with liquids at their manufacturing facilities, which are remote from the physical location. The second entities may then seal the smaller containers using caps, adhesives, and/or other seals. The second entities can be different from the first entity. The smaller containers can then be transported, for example by distributors that may be different from the first and second entities, from the manufacturing facilities to the physical location.

In block 204, a user can select a smaller container from among the multiple smaller containers.

Blocks 206-214 can then be performed. These steps may be similar to blocks 104-112 of FIG. 1. As shown by the return arrow from block 214 to block 204, these steps can be repeated for each of the smaller containers. This may cause the multiple smaller containers to pour liquids into the multiple larger containers concurrently with one another in a hands-free manner.

In block 216, the smaller containers are detached from the larger containers. For example, the user can sequentially detach each smaller container from each larger container one-by-one. This step can be performed similarly to block 116 of FIG. 1.

In block 218, some or all of the smaller containers can be discarded. This step can be performed similarly to block 118 of FIG. 1.

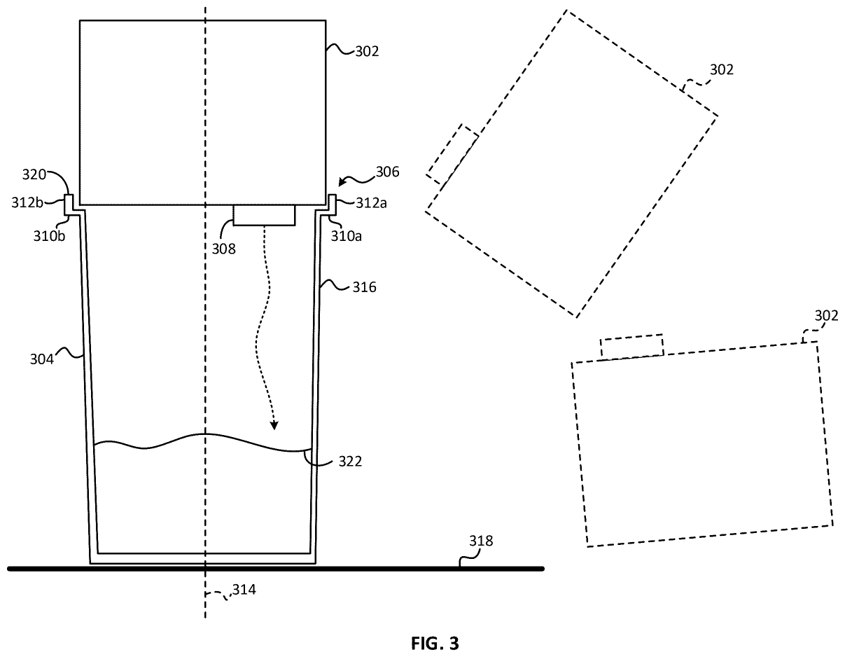

Turning now to FIG. 3, shown is a cross-sectional side view of an example of a first container 302 attached to a second container 304 via an attachment assembly 306 according to some aspects of the present disclosure. In this example, the first container 302 is sized to hold a smaller volume of liquid than the second container 304. The first container 302 has a single nozzle 308 through which the liquid can be poured into the second container 304, but is otherwise completely enclosed on all sides such that it has no other openings.

In this example, the second container 304 has an integrated attachment assembly 306. In particular, the attachment assembly 306 is formed into a wall of the second container 304. In other examples, the attachment assembly 306 may be a separate component that is retrofitted onto the second container 304.

The attachment assembly 306 can include ledge portions 310a-b. The ledge portions 310a-b can be discrete ledges or different portions of a single continuous ledge, which may extend around a perimeter of the second container 304. The ledge portions 310a-b can be vertically positioned beneath a rim 320 of the second container 304. ledge portions 310a-b may have a first end (e.g., a proximal end) coupled to a recessed portion 316 of the second container 304. The ledge portions 310a-b can extend radially outwardly (in a direction away from a central longitudinal axis 314 of the second container 304) from the first portion 316, such that the recessed portion 316 has an outer diameter than is smaller than an outer diameter of the ledge portions 310a-b. The ledge portions 310a-b may be substantially perpendicular to the central longitudinal axis 314 of the first container 302. As used herein, a first element can be considered “substantially perpendicular” to a second element when the first element is perpendicular to the second element or within 5 degrees thereof. The ledge 310 can support the first container 302 in the inverted position.

The attachment assembly 306 can also include side wall portions 312a-b. The side wall portions 312a-b can be discrete sidewalls or different portions of a single continuous sidewall, which can extend around a perimeter of the second container 304. The side wall portions 312a-b can extend outwardly from the ledge portions 310a-b in an axial direction—e.g., in a direction along the central longitudinal axis 314 of the second container 304. For example, the side wall portion 312a can extend upwardly from a second end (e.g., a distal end) of the ledge portions 310a. The side wall portions 312a-b can guide the user in the insertion process. The feeling of inserting the first container 302 into the attachment assembly 306 (e.g., until it abuts the ledge 310) can provide valuable tactile feedback to the user to indicate whether the attachment was successful. The side wall portions 312a-b can also help secure the first container 302 in position to prevent it from toppling or sliding. For example, the side wall portions 312a-b can prevent lateral movement of the first container 302. In some examples, the inner surface of the side wall portions 312a-b can engage with the first container's 302 outer wall to produce an interference fit, which may help secure the first container 302 to the second container 304.

As noted above, the attachment assembly 306 can include multiple discrete ledges and/or multiple discrete side walls around the perimeter of the second container 304. This may use less material than a single continuous ledge and/or side wall around the perimeter, which can reduce manufacturing costs.

To use the attachment assembly 306, a user can rotate the first container 302 (as shown in dashed lines) and insert it into the attachment assembly 306 of the second container 304. The first container 302 can be sized to fit into the attachment assembly 306. For example, the first container's 302 perimeter can be sized to cooperate with the attachment assembly 306. If the first container 302 is open, gravity will cause the first container 302 to pour liquid into the second container 304, as represented by a dashed arrow. After the first container 302 is attached to the second container 304, the user can remove their hands from the first container 302, so that a remainder (e.g., majority) of the pouring occurs in a hands-free manner. During this process, the ledge portions 310a-b and/or side wall portions 312a-b may remain in contact with the first container 302 (e.g., its top and side walls).

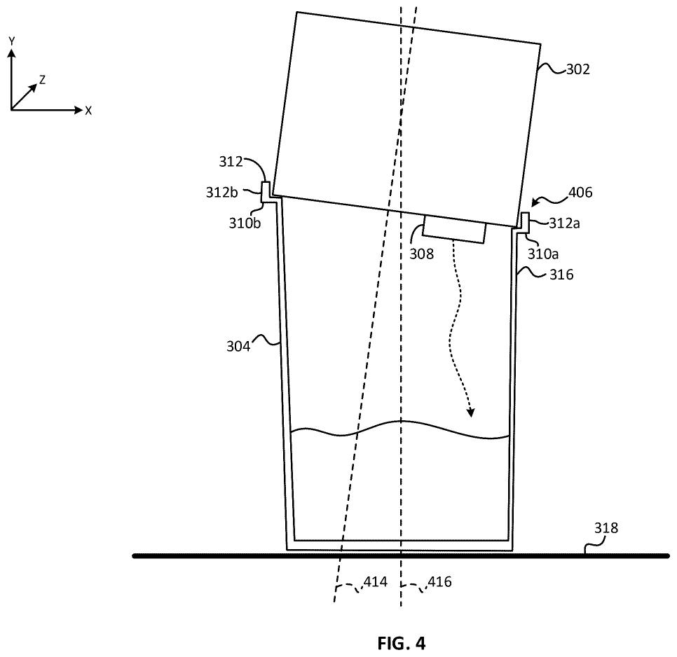

During the pouring process, the second container 304 can rest on a surface 318, such as a table or counter. In this example, the attachment assembly 306 is configured to maintain a central longitudinal axis 314 of the first container 302 substantially perpendicular to the surface 318 during the pouring. But in other examples, such as the example shown in FIG. 4, the attachment assembly 306 may be configured to maintain the central longitudinal axis 314 of the first container 302 at a slant (e.g., oblique angle) relative to the surface 318 during the pouring.

In some examples, the attachment assembly 306 can be configured to maintain the first container 302 (e.g., its lowest point, such as the nozzle 308) above a fill level 322 of the second container 304. The attachment assembly 306 can maintain the first container 302 above the fill level 322 throughout the entire pouring process. This can prevent the liquid in the second container 304 from contacting the outer surface of the first container 302, which may prevent against contamination (e.g., if the outer surface of the first container 302 got dirty during transport).

FIG. 4 depicts a cross-sectional side view of another example of a first container 302 attached to a second container 304 via an attachment assembly 406 according to some aspects of the present disclosure. This example functions similarly to that of FIG. 3, except the attachment assembly 406 is slanted.

In particular, the attachment assembly 406 can include a first ledge portion 310a and a second ledge portion 310b. As noted above, the first and second ledge portions 310a-b can be discrete ledges or different portions of a single continuous ledge. The first ledge portion 310a can be vertically positioned (e.g., along the Y-axis shown in FIG. 4) lower than the second ledge portion 310b.

The attachment assembly 406 may also include a first sidewall portion 312a and a second sidewall portion 312b. As noted above, the first and second sidewall portions 312a-b can be discrete sidewalls or different portions of a single continuous sidewall. The first sidewall portion 312a can be vertically positioned (e.g., along the Y-axis shown in FIG. 4) lower than a second sidewall portion 312b. This may cause the rim 312 of the second container 304 to be slanted relative to the central longitudinal axis 416 of the second container 304.

In the arrangement shown in FIG. 4, the attachment assembly 406 can be configured to maintain the central longitudinal axis 414 of the first container 302 at an inclined angle (e.g., a slant) relative to the surface 318 and/or the central longitudinal axis 416 of the second container 304. This may be less stable but allow for better liquid transfer via gravity than the arrangement shown in FIG. 3.

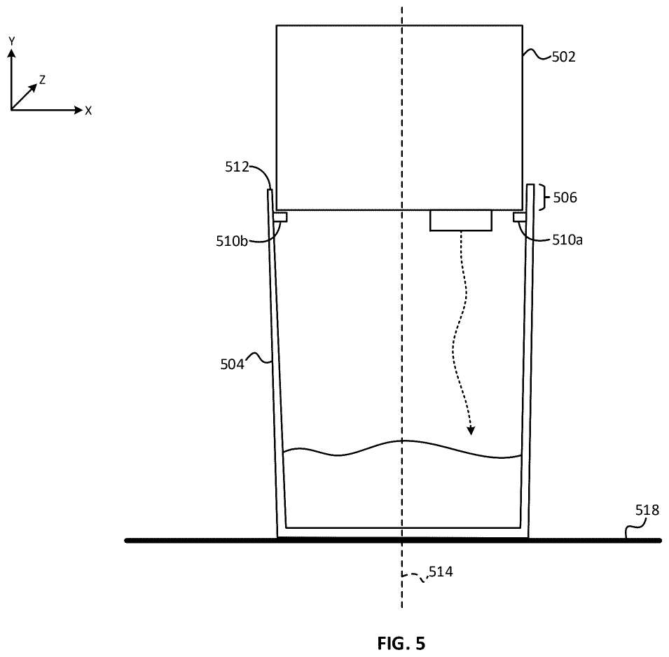

FIG. 5 depicts a cross-sectional side view of another example of a first container 502 attached to a second container 504 via an attachment assembly according to some aspects of the present disclosure. In this example, the attachment assembly can include ledge portions 510a-b. The ledge portions 510a-b may be discrete ledges or may be different portions of a single continuous ledge. The ledge portions 510a-b can protrude inwardly from an inner wall of the second container 504. For example, the ledge portions 510a-b can extend radially inwardly toward a central longitudinal axis 514 of the second container 504. The ledge portions 510a-b can be positioned vertically beneath a rim 512 of the second container 504. The ledge portions 510a-b can support the first container 502 in the inverted position.

The second container 504 can include an upper portion 506, which can form part of the attachment assembly. The “upper portion” of a container may consist of the uppermost 15% or less of the container. For instance, the “upper portion” of a container may be the uppermost 3%, 5%, 7%, 10%, 13%, or 15% of the container. The upper portion 506 can serve a similar function as the side wall portions 312a-b of FIG. 3. For example, the upper portion 506 may prevent lateral movement and serve as a guide for the user in attaching the first container 502 to the second container 504. In some examples, the outer wall of the first container 502 may engage with the inner surface of the upper portion 506 of the second container 504 to produce an interference fit. This may secure the first container 502 to the second container 504, so that the first container 502 cannot easily topple or slide off. The feeling of inserting the first container 502 into the attachment assembly (e.g., until it abuts the ledge portions 510a-b) can provide valuable tactile feedback to the user to indicate whether the attachment was successful.

In the example shown in FIG. 5, the ledge portions 510a-b are positioned at the same height in the second container 504. This can maintain a central longitudinal axis 514 of the first container 502 substantially perpendicular to the surface 518 during the pouring. But in other examples, the ledge portions 510a-b can be positioned at different heights in the second container 504. This may maintain the central longitudinal axis 514 of the first container 302 at an inclined angle (e.g., a slant) relative to the surface 518 during the pouring, similar to the arrangement shown in FIG. 4.

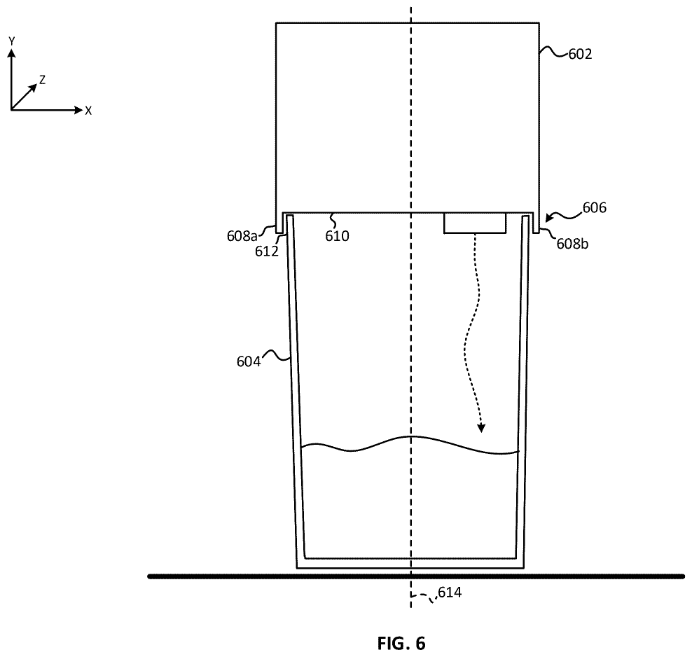

FIG. 6 depicts a cross-sectional side view of another example of a first container 602 attached to a second container 604 via an attachment assembly 606 according to some aspects of the present disclosure. In this example, the attachment assembly 606 is integrated into the first container 602 rather than the second container 604. The attachment assembly 606 can include side wall portions 608a-b. The side wall portions 608a-b can be discrete sidewalls or different portions of a single continuous sidewall, which can extend around an outer perimeter of the first container 602. The side wall portions 608a-b can extend in an axial direction (e.g., in a direction along a central longitudinal axis 614 of the first container 602). For example, the first container 602 may include multiple discrete side walls extending outwardly in an axial direction (e.g., downwardly when the first container 602 is in the inverted position) from a top surface 610 of the first container 602.

The attachment assembly 606 can operate as follows. The first container 602 can be slid down onto the second container 604—e.g., until the rim of the second container 604 abuts the top surface 610 of the first container 602. The feeling of sliding the second container 604 into the attachment assembly (e.g., until it abuts the top surface 610 of the first container 602) can provide valuable tactile feedback to the user to indicate whether the attachment was successful. In some examples, the inner surfaces of the side wall portions 608a-b can contact and engage with the outer surface 612 of the second container 604 to produce an interference fit. This may help secure the first container 602 on top of the second container 604, so that the first container 602 cannot easily topple or slide off.

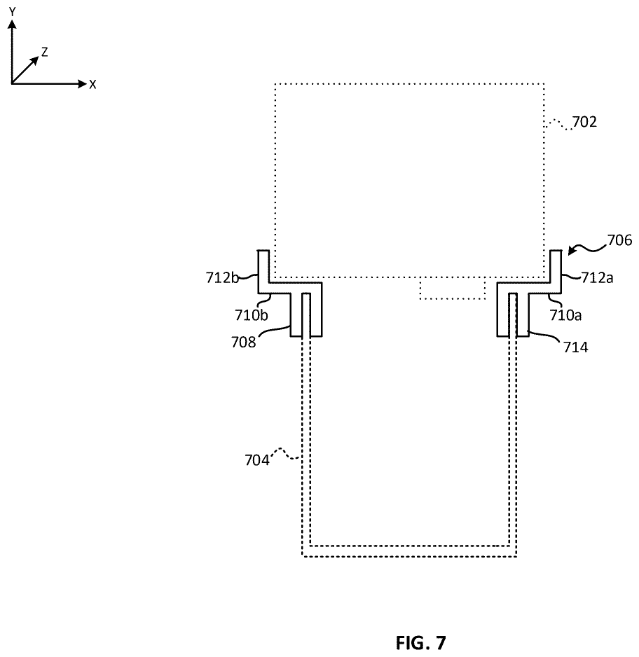

FIG. 7 depicts a cross-sectional side view of an example an attachment assembly 706 according to some aspects of the present disclosure. In this example, the attachment assembly 706 can be provided separately from the second container 704 and retrofitted onto the second container 704 at a physical location, such as a store. For example, the second container 704 may be received at the physical location from a first entity, such as a first manufacturer. The attachment assembly 706 may be received at the physical location from a second entity, such as a second manufacturer. The second entity can be different from the first entity. The physical location can be associated with a third entity, which can be different from the first entity and/or second entity. The attachment assembly 706 may be formed from plastic, metal, etc.

Once at the physical location, the attachment assembly 706 can be permanently or removably fixed to the second container 704 with a coupling mechanism 708, such as one or more screws, glues, bolts, clamps, arms, or any combination of these. In the example shown in FIG. 7, the coupling mechanism 708 can include one or more arms 714 extending in an axial direction (e.g., downwardly). The arms 714 can be spaced apart from each other to receive a wall of the second container 704 therebetween. For example, the arms 714 can be configured to receive, and may create an interference fit with, the periphery of the second container 704. For example, the arms 714 can include a first arm and a second arm. The first arm can be configured to contact an inner surface of the second container 704, and the second arm can be configured to contact an outer surface of the second container 704. When the coupling mechanism 708 is attached to the second container 704, the first and second arms can receive and contact the lip of the second container 704 to maintain the lip therebetween. This may yield an interference fit, which can secure the attachment assembly 706 to the second container 704. If the attachment assembly 706 is removably fixed to the second container 704, the coupling mechanism 708 can be selectively disengaged to remove the attachment assembly 706 from the second container 704. For example, the interference fit can be overcome to remove the attachment assembly 706 from the second container 704. This may allow for easier repair, replacement, or cleaning of the attachment assembly 706 and/or second container 704.

In some examples, there can be multiple attachment assemblies configured to cooperate with first containers having different exterior profiles (e.g., shapes and sizes). The attachment assemblies can be interchangeably fixed to the second container as needed. For example, a user can select the appropriate attachment assembly for a given first container. The user can then removably fix the attachment assembly to the second container for use with that first container.

It may be desirable to prevent the attachment assembly 706 from accidentally disconnecting from the second container 704, which may result in spillage or injury. This may occur if, for example, a user lifts the second container 704 (e.g., once it's full) by the attachment assembly 706, such as the ledge portions 710a-b. To prevent such accidents, multiple different types of coupling mechanisms may be used in combination with each other. For example, bolts or screws may be inserted through the arms 714 to reinforce the interference fit or otherwise securely couple the attachment assembly 706 to the second container 704.

The attachment assembly 706 may operate similarly to the one shown in FIG. 3. For example, the attachment assembly 706 can have ledge portions 710a-b and sidewall portions 712a-b. The ledge portions 710a-b may be discrete ledges or different portions of a single continuous ledge. The sidewall portions 712a-b may be discrete sidewalls or different portions of a single continuous sidewall. The ledge portions 710a-b and sidewall portions 712a-b can receive and maintain the first container 702 in an inverted position over the second container 704. During this process, the ledge portions 710a-b and/or sidewall portions 712a-b may remain in contact with the first container 702 (e.g., its top and side walls). This can allow for hands-free pouring from the first container 702 to the second container 704.

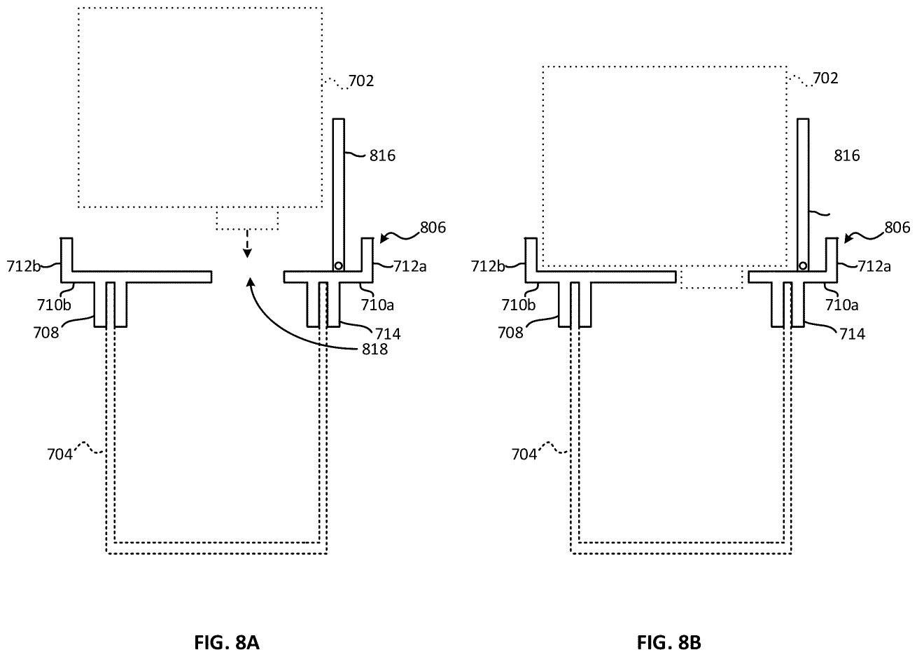

FIGS. 8A-B depict cross-sectional side views of an example an attachment assembly 806 according to some aspects of the present disclosure. In this example, the attachment assembly 806 can be provided separately from the second container 704 and retrofitted onto the second container 704 at a physical location, similar to the example shown in FIG. 7. For example, the second container 704 may be received at the physical location from a first entity, such as a first manufacturer. The attachment assembly 706 may be received at the physical location from a second entity, such as a second manufacturer. The second entity can be different from the first entity. The physical location can be associated with a third entity, which can be different from the first entity and/or second entity. The attachment assembly 706 may be formed from plastic, metal, etc.

In this example, the attachment assembly 806 can serve a dual purpose as a lid for the second container 704. For example, the attachment assembly 806 may serve as a lid to prevent contaminants from entering the second container 704 when the second container 704 is attached to a piece of equipment, such as a liquid dispenser. When fixed to the second container 704, the attachment assembly 806 can substantially cover the entire opening of the second container 704, with the exception of a mouth 818 that is coverable by a sealing element 816. The sealing element 816 is movable between (i) a closed position to seal the second container 804 and (ii) an open position for filling the second container 704. When in the open position, for example as shown in FIGS. 8A-B, the sealing element 816 can allow for fluid to be poured from the first container 702 into the second container 704. When in the closed position, the sealing element 816 can seal contents of the second container 704 from the external environment.

To use the attachment mechanism 806, the sealing element 816 can be moved to the open position. For example, the sealing element 816 can be rotatably coupled at one end to the attachment mechanism 806 by a rotating member. The sealing element 816 can thus be rotated from the closed position to the open position. The first container 702 can then be inserted into the attachment assembly 806, for example so that a nozzle of the first container 702 sits within the mouth 818 of the lid, as shown in FIG. 8B. This can allow fluid flow from the first container 702 into the second container 704. Once the fluid transfer is complete, the first container 702 can be removed from the attachment mechanism 806 and the sealing element 816 can be moved to the closed position. For example, the sealing element 816 can be rotated from the open position to the closed position.

The above description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, some examples described herein can be combined with other examples to yield further examples.

1. A method performed at a physical location, the method comprising:
positioning a first container containing a liquid above a second container, wherein the first container is prefilled with the liquid prior to arriving at the physical location;
rotating the first container into an inverted position to begin pouring the liquid out an opening of the first container into the second container; and
while the liquid is pouring from the first container into the second container, securing the first container in the inverted position to the second container using an attachment assembly, wherein the attachment assembly maintains the first container in the inverted position overtop of the second container without manual intervention, thereby allowing the liquid to flow through the opening of the first container into the second container without continuous manual effort.

2. The method of claim 1, further comprising:
after the liquid is poured into the second container, disengaging the first container from the attachment assembly of the second container; and
after disengaging the first container from the attachment assembly, discarding the first container.

3. The method of claim 1, wherein the attachment assembly is formed as an integral part of the second container, such that the attachment assembly and the second container constitute a single unit.

4. The method of claim 3, wherein the attachment assembly includes a ledge portion extending radially outwardly relative to a central longitudinal axis of the second container, and wherein the attachment assembly includes a sidewall portion extending axially upwardly from the ledge portion, the sidewall portion forming a rim of the second container.

5. The method of claim 1, wherein the attachment assembly engages with an exterior surface of the first container to secure the first container to the second container during the pouring.

6. The method of claim 1, wherein the second container is positioned on a surface during the pouring, and wherein the attachment assembly maintains a central longitudinal axis of the first container substantially perpendicular to the surface during the pouring.

7. The method of claim 1, wherein the second container is positioned on a surface during the pouring, and wherein the attachment assembly maintains a central longitudinal axis of the first container at an inclined angle relative to the surface during the pouring.

8. The method of claim 1, wherein the attachment assembly includes at least one ledge portion extending radially inwardly from an interior surface of the second container, wherein the first container rests on the at least one ledge portion, thereby maintaining the first container in the inverted position.

9. The method of claim 1, wherein the first container has only a single opening.

10. The method of claim 1, further comprising, prior to positioning the first container above the second container:
receiving the first container at the physical location, wherein the first container is sealed prior to arriving at the physical location; and
opening the first container by removing a cap or seal from the first container.

11. The method of claim 1, wherein the first container is sized to hold less liquid than the second container.

12. The method of claim 1, wherein the second container is a reservoir for liquid dispensing equipment at the physical location.

13. The method of claim 1, wherein the second container is substantially empty prior to the pouring, and wherein there is a gap between the first container and the second container when the first container is positioned above the second container.

14. The method of claim 1, wherein the liquid is a first liquid, and further comprising:
receiving a third container that is prefilled with a second liquid and sealed prior to arriving at the physical location, the second liquid being different from the first liquid;
opening the third container; and
while the first liquid is pouring from the first container into the second container:
rotating the third container into an inverted position to begin pouring the second liquid into a fourth container; and
while the second liquid is pouring from the third container into the fourth container, securing the third container in the inverted position to the fourth container using a second attachment assembly coupled to the fourth container, wherein the second attachment assembly maintains the third container in the inverted position over the fourth container without manual intervention, such that the second liquid is poured into the fourth container while the first liquid is simultaneously poured into the second container.

15. The method of claim 1, wherein the attachment assembly maintains the first container above a fill level of the second container to prevent contents of the second container from contacting an outer surface of the first container.

16. A system comprising:
a first container including a liquid and only a single opening, the single opening being positioned to allow the liquid to flow out of the first container when the first container is in an inverted position;
a second container including a wall defining an interior area for receiving the liquid; and
an attachment assembly coupled to the wall of the second container, wherein the attachment assembly is configured to maintain the first container in the inverted position during a pouring operation, thereby allowing the liquid to be poured through the single opening of the first container into the second container without continuous manual effort.

17. The system of claim 16, wherein the attachment assembly is formed as an integral part of the second container, such that the attachment assembly and the second container constitute a single unit.

18. The system of claim 16, wherein the first container is a single-use container.

19. The system of claim 16, wherein the attachment assembly includes a ledge portion extending radially outwardly relative to a central longitudinal axis of the second container, and wherein the attachment assembly includes a sidewall portion extending axially upwardly from the ledge portion.

20. A container comprising:
a wall defining an interior area for receiving a liquid; and
an attachment assembly coupled to the wall, the attachment assembly being configured to maintain a second container in an inverted position overtop of the container, thereby allowing the liquid to be poured from the second container into the container without continuous manual effort, wherein the second container has only a single opening.
